(19) United States
(12) Patent Application Publication
(10) Pub. No.: US 2010/0275160 A1
(43) Pub. Date: Oct. 28, 2010

(54) METHOD AND APPARATUS FOR TOUCH INPUT IN PORTABLE TERMINAL

(75) Inventor: Tae-Soon IM, Suwon-si (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/765,089

(22) Filed: Apr. 22, 2010

(30) Foreign Application Priority Data
Apr. 22, 2009 (KR) 10-2009-0034897

(51) Int. Cl. G06F 3/048; G06F 3/041; G06F 3/033

(52) U.S. Cl. 715/810; 345/173; 715/863

(57) ABSTRACT

An apparatus and method for determining a character that can be combined with a first selected character and then outputting a character obtained by combining the characters so as to enable a fast and quick character input by simplifying a character input process in a portable terminal are provided. The apparatus includes a combination character determination unit for receiving character data selected on a character input screen comprising a plurality of pieces of character data, for determining character data that can be combined with the selected character data, and for outputting a combination character obtained by combining the determined character data with the character data selected on the input screen.

### CLAIM OF PRIORITY

This application claims the benefit of the earlier filing date, under 35 U.S.C. §119(a), of that Korean patent application filed in the Korean Intellectual Property Office on Apr. 22, 2009 and assigned Serial No. 10-2009-0034897, the entire disclosure of which is hereby incorporated by reference in its entirety.

### BACKGROUND OF THE INVENTION

1. Field of the Invention

The present invention relates to the field of positional determination and in particular to an apparatus and method for inputting a character in a portable terminal. More particularly, the present invention relates to an apparatus and method for determining a character that can be combined with a first selected character and then outputting a character obtained by combining the characters so as to enable a fast and quick character input through a simplified character input process.

2. Description of the Related Art

Portable terminals have recently been widely used due to convenience of portability. Currently, service providers (or terminal manufacturers) are competitively developing the portable terminals having more convenient functions to attract more users.

For example, the portable terminal provides various functions such as phonebooks, games, schedulers, short messaging services, multimedia message services, broadcast message services, Internet services, e-mails, wake-up calls, MPEG Layer 3 (MP3) players, digital cameras, etc.

With the development of a touch screen-type portable terminal for inputting data by using a user's finger or a stylus pen, a user can easily and simply write a text or draw a line on the portable terminal by using the stylus pen.

The portable terminal can receive a data input when a specific menu displayed on a display unit is selected, or when a character is directly written on the screen using the stylus pen.

The aforementioned function has a problem in that a plurality of key inputs is performed when character data is input. For example, a character input function provided by a typical portable terminal performs one character input by multiple inputs of a consonant, a vowel, a direction key, a stroke add key, etc.

In addition, when a character is input by a touch input, there is a drawback of inputting all respective characters to be selected and combined, thereby requiring a large number of operations in a character input process. That is, the character input process of the typical portable terminal requires a plurality of key input operations.

Accordingly, there is a need for an apparatus and method for simplifying a character data input process to decrease a character input time for the portable terminal.

### SUMMARY OF THE INVENTION

An exemplary aspect of the present invention is to provide an apparatus and method for enabling a faster and quicker character input by simplifying a character input process in a portable terminal.

Another exemplary aspect of the present invention is to provide an apparatus and method for determining a character that can be combined with a first selected character and then outputting a character obtained by combining the characters in a portable terminal.

Still another exemplary aspect of the present invention is to provide an apparatus and method for combining a character corresponding to a touch direction with a first selected character in a portable terminal.

In accordance with an aspect of the present invention, an apparatus for inputting a character in a portable terminal is provided. The apparatus includes a combination character determination unit for receiving character data selected on a character input screen comprising a plurality of pieces of character data, and then determining character data that can be combined with the selected character data, and a controller for outputting a combination character obtained by combining characters determined by the combination character determination unit.

In accordance with another aspect of the present invention, a method of inputting a character in a portable terminal is provided. The method includes receiving character data selected on a character input screen comprising a plurality of pieces of character data, and then determining character data that can be combined with the selected character data, and outputting a combination character obtained by combining the character data.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating a structure of a portable terminal for simplifying a character input process according to the present invention;

FIG. 2 is a flowchart illustrating a character input process of a portable terminal according to the present invention;

FIG. 3 is a flowchart illustrating a character input process of a portable terminal according to an exemplary embodiment of the present invention;

FIG. 4 is a flowchart illustrating a character input process of a portable terminal according to another embodiment of the present invention;

FIG. 5A illustrates a process of inputting a character [symbol] by using a portable terminal according to the present invention;

FIG. 5B illustrates a process of inputting a character [symbol] by using a portable terminal according to the present invention;

FIG. 5C illustrates a process of inputting a character by using a portable terminal according to the present invention;

FIG. 5D illustrates a character input process of a portable terminal according to an exemplary embodiment of the present invention; and

FIG. 5E illustrates a character input process of a portable terminal according to another exemplary embodiment of the present invention.

### DETAILED DESCRIPTION OF THE INVENTION

The following description, with reference to the accompanying drawings, is provided to assist in a comprehensive understanding of certain exemplary embodiments of the invention provided herein for illustrative purposes. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Also, descriptions of well-known functions and constructions may be omitted for clarity and conciseness when their inclusion may obscure appreciation of the subject matter of the claimed invention by a person or ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

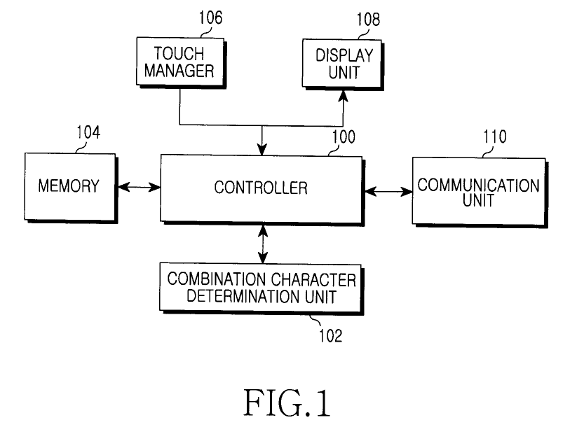

FIG. 1 is a block diagram illustrating a structure of a portable terminal for simplifying a character input process according to the present invention.

Referring to FIG. 1, the portable terminal may include a controller 100, a combination character determination unit 102, a memory 104, a touch manager 106, a display unit 108, and a communication unit 110.

The controller 100 provides overall control of the portable terminal. For example, the controller 100 processes and controls voice calls and data communications. The controller 100 also provides control such that a user of the portable terminal can determine a character that can be combined with a first selected character and then outputs a character obtained by combining the characters to the display unit 108, thus simplifying the character input process of the portable terminal.

In this case, the controller 100 may provide control such that characters are combined by determining only a combination character corresponding to a touch direction or by determining all combination characters that can be combined with the first selected character.

Under the control of the controller 100, the combination character determination unit 102 determines a character that can be combined with a character selected by the user of the portable terminal, and allows the display unit 108 to output a character obtained by combining the determined character with the character selected by the user.

The memory 104 includes a Read Only Memory (ROM), a Random Access Memory (RAM), and a flash ROM, and the like. The ROM stores a microcode of a program, by which the controller 100 and the combination character determination unit 102 are processed and controlled, and a variety of reference data.

The RAM is a working memory of the controller 100 and stores temporary data that is generated while programs are performed. The flash ROM stores a variety of rewritable data, such as phonebook entries, outgoing messages, incoming messages, and information on a user's touch input point, and the like.

The touch manager 106 detects a touch input of the user under the instruction of the controller 100, so as to perform an operation depending on the touch input. That is, at the occurrence of the touch input of the user, the touch manager 106 provides the controller 100 with a position of a specific point at which the touch input occurs, or the touch manager 106 determines data corresponding to the specific point and allows the display 108 to display the data.

The display unit 108 displays information such as state information, which is generated while the portable terminal operates, limited numeral characters, large-sized moving and still pictures, and the like. The display unit 108 may be a color Liquid Crystal Display (LCD), Active Mode Organic Light Emitting Diode (AMOLED), and the like. When the display unit 108 is equipped with a touch input device, the display unit 108 may be used as an input device.

The communication unit 110 transmits and receives a Radio Frequency (RF) signal of data that is input and output through an antenna (not shown). For example, in transmission, data to be transmitted is subject to a channel-coding process and a spreading process, and then the data is transformed to an RF signal. In reception, the RF signal is received and transformed to a base-band signal, and the base-band signal is subject to a de-spreading process and a channel-decoding process, thereby restoring the data.

Although a function of the combination character determination unit 102 can be performed by the controller 100, the combination character determination unit 102 and the controller 100 are separately constructed in the present invention for exemplary purposes only. Thus, those ordinary skilled in the art can understand that various modifications can be made within the scope of the present invention. For example, functions of the combination character determination unit 102 and the controller 100 can be integrally configured to be processed by the controller 100.

Hereinafter, a method of determining a character that can be combined with a first selected character and then outputting a character obtained by combining the characters so as to enable a faster and quicker character input through a simplified a character input process in a portable terminal will be described using the aforementioned apparatus according to an exemplary embodiment of the present invention.

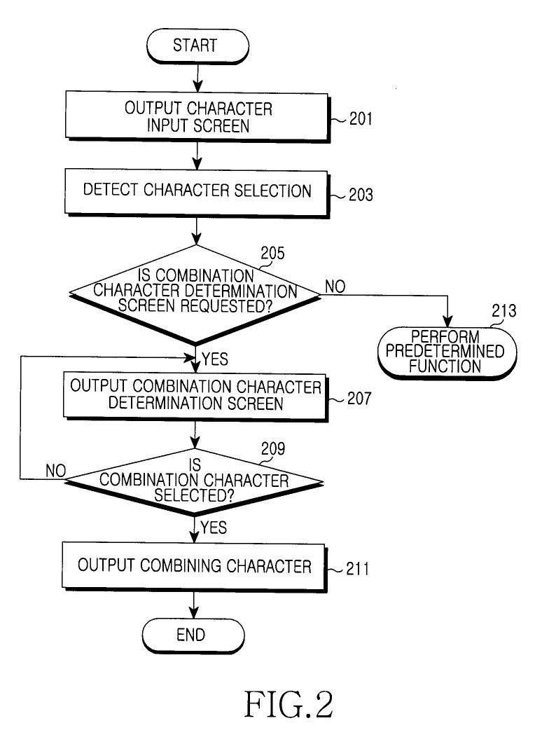

FIG. 2 is a flowchart illustrating a character input process of a portable terminal according to the present invention.

Referring to FIG. 2, the portable terminal outputs a character input screen in step 201. The character input screen enables a user to select a character, and is a screen on which a consonant and a vowel are separately output to enable stepwise character combinations in accordance with the present invention.

In step 203, the portable terminal determines whether the user select any one character from the existing character input screen. In step 205, the portable terminal determines whether a combination character determination request is detected.

The combination character determination request is a request for outputting a screen consisting of characters that can be combined with the character selected by the user of the portable terminal in step 203. The user of the portable terminal may select the character according to a touch input mechanism and thereafter performs the request by changing a touch input point from the selected point.

If the combination character determination request does not occur in step 205, proceeding to step 213, the portable terminal performs a predetermined function (e.g., character selection detection, etc.).

If the combination character determination request occurs in step 205, proceeding to step 207, the portable terminal outputs a combination screen determination screen. In step 209, the portable terminal determines whether a combination character is selected by the user on the existing combination character determination screen.

If the combination character is not selected in step 209, the procedure returns to step 207.

If the combination character is selected in step 209, proceeding to step 211, the portable terminal outputs to the display unit the combination character selected in step 209 by the user. Thereafter, the procedure of FIG. 2 ends.

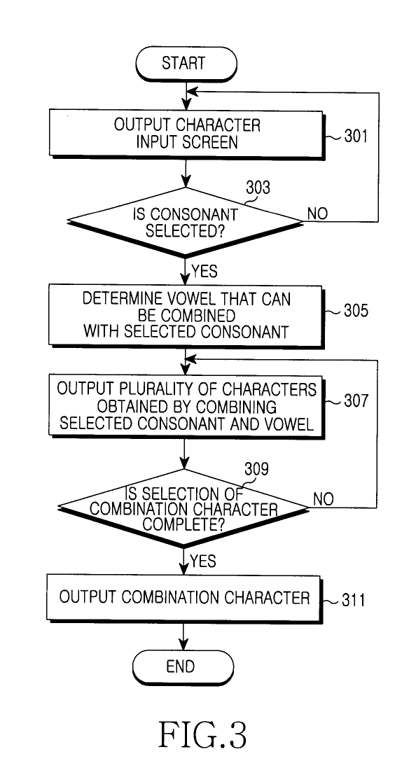

FIG. 3 is a flowchart illustrating a character input process of a portable terminal according to an exemplary embodiment of the present invention.

Referring to FIG. 3, the portable terminal outputs a character input screen in step 301. The character input screen is a screen provided to enable a user to select a character, and is a screen on which a consonant and a vowel are separately output to enable stepwise character combinations according to the present invention.

In step 303, the portable terminal determines whether the user of the portable terminal selects a consonant on the existing character input screen. It is assumed in FIG. 3 that the user first selects a consonant according to the exemplary embodiment of the present invention in which a combination character is selected by a consonant plus vowel combination.

If the user does not select the consonant in step 303, the procedure returns to step 301. Although the procedure returns to step 301 if the consonant is not selected, another character may be selected and output.

Otherwise, if the user selects the consonant and thus a combination character determination request occurs, proceeding to step 305, the portable terminal determines a vowel that can be combined with the consonant selected by the user. For example, if the consonant first selected by the user is a consonant [symbol] , i.e., one of basic consonants of the Korean alphabet, the portable terminal determines Korean vowels (e.g., [symbol] -, etc.) that can be combined with the consonant [symbol] . It should be noted that Korean alphabets are used for illustrative purposes, but the teachings of the present invention may be applied to other language requiring an assembly with a combination of characters.

In step 307, the portable terminal allows a display unit to output a plurality of characters obtained by combining the selected consonant and the vowels that can be combined with the selected consonant. That is, the portable terminal allows the display unit to output characters such as [symbol] [symbol] etc.” obtained by combining the selected consonant [symbol] and all possible vowels that can be combined with the selected consonant.

In step 309, the portable terminal determines whether the user of the portable terminal selects any one of combination characters among the combined characters output in step 307.

If it is determined in step 309 that the user of the portable terminal does not select any combination character, the procedure returns to step 307.

Otherwise, if the user of the portable terminal selects a combination character and thus a combination character determination request occurs, proceeding to step 311, the portable terminal allows the display unit to output the combination character selected by the user.

Thereafter, the procedure of FIG. 3 ends.

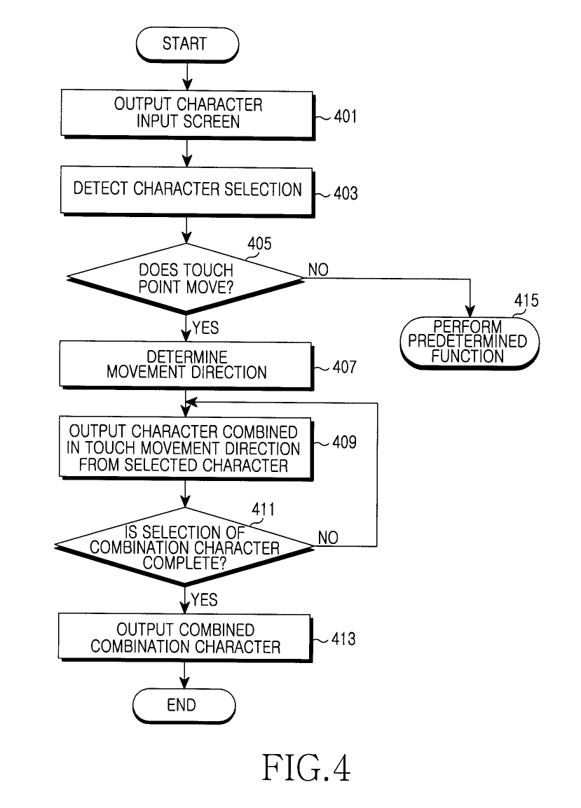

FIG. 4 is a flowchart illustrating a character input process of a portable terminal according to another embodiment of the present invention.

Referring to FIG. 4, the portable terminal outputs a character input screen in step 401. The character input screen is a screen provided to enable a user to select a character, and is a screen on which a consonant and a vowel are separately output to enable stepwise character combinations according to the present invention.

In step 403, the portable terminal detects whether the user of the portable terminal selects any one character on the existing character input screen. In step 405, the portable terminal determines whether a touch point moves. The movement of the touch point implies that the user of the portable terminal selects a character according to a touch input mechanism in step 403 and thereafter changes a touch input point from a point where the character is selected.

If it is determined in step 405 that the touch point does not move, proceeding to step 415, the portable terminal performs a predetermined function (e.g., selected character output, etc.).

Otherwise, if the touch point moves, proceeding to step 407, the portable terminal determines a direction of the touch point movement. In step 409, the portable terminal outputs a character combined in the touch movement direction from the selected character.

That is, the portable terminal determines a character that can be combined in a direction corresponding to the touch point movement direction and combines this character with the selected character.

For example, if the user selects a consonant character [symbol] and then moves a touch point to the right, the portable terminal combines a character that can be combined to the right of the consonant character [symbol] . Accordingly, the portable terminal determines and combines vowel characters that can be combined to the right of the consonant character [symbol] , such as [symbol] [symbol] , etc.

Meanwhile, if the user selects the consonant character [symbol] and then moves the touch point downwards, the portable terminal combines a character that can be combined to the bottom of the consonant character [symbol] . Accordingly, the portable terminal determines and combines vowel characters that can be combined to the bottom of the consonant character [symbol] , such as [symbol] [symbol] , etc.

In addition, if the user selects the consonant character [symbol] and then moves the touch point to the right-bottom (at a slant angle between the right and bottom directions), the portable terminal combines a character that can be combined to the right-bottom of the consonant character [symbol] . Accordingly, the portable terminal determines and combines vowel characters that can be combined to the right-bottom of the consonant character [symbol] , such as [symbol] [symbol] , etc.

In step 411, the portable terminal determines whether the user of the portable terminal selects any one of combination characters.

If it is not determined in step 411 that the user does not complete the selection of the combination character, the procedure returns to step 409.

Otherwise, if the user completes the selection of the combination character, proceeding to step 413, the portable terminal allows the display unit to output the combined combination character selected by the user.

Thereafter, the procedure of FIG. 4 ends.

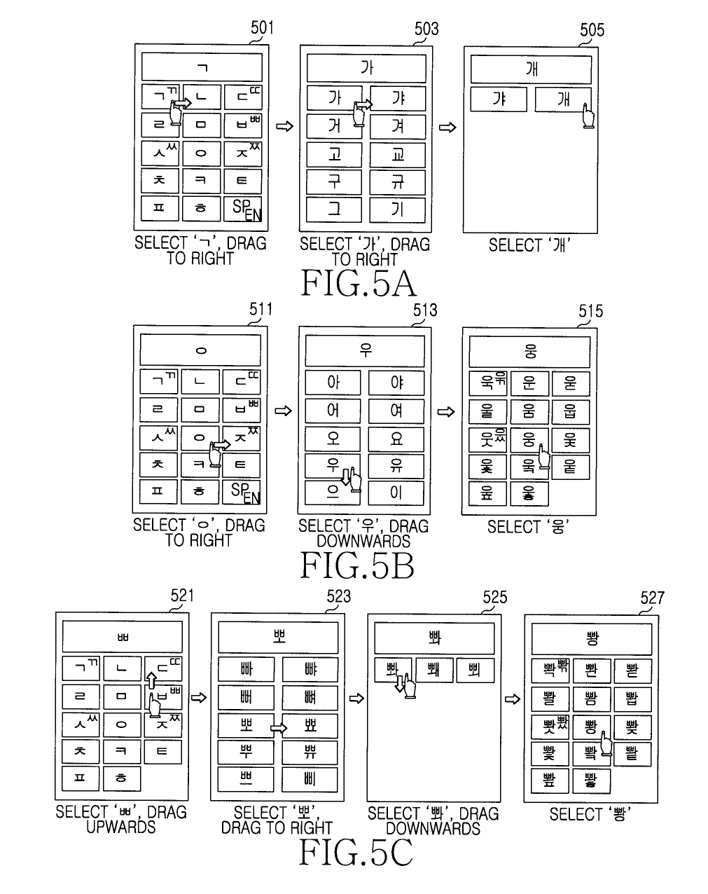

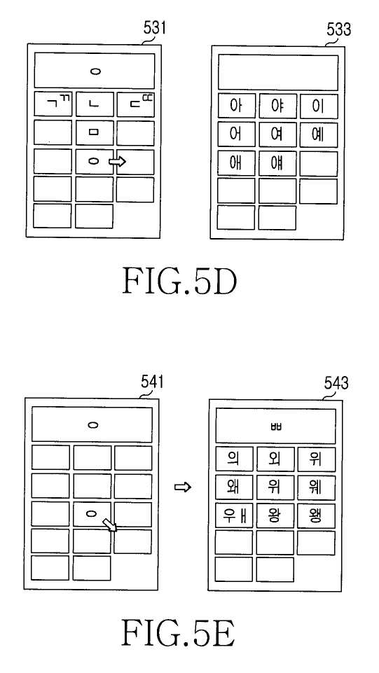

FIG. 5 illustrates a character input screen of a portable terminal according to an exemplary embodiment of the present invention.

Referring to FIG. 5, upon detecting a touch point movement to the right after a consonant character is selected, the portable terminal outputs a combination character obtained by combining the selected character and a vowel character. Further, upon detecting a touch point movement downwards after the consonant character is selected, the portable terminal outputs a combination character obtained by combining the selected character and a final consonant character.

Furthermore, upon detecting a touch movement upwards after the consonant character is selected to be described below, the portable terminal output a double consonant (or fortis) of the selected character.

FIG. 5A illustrates a process of inputting a character [symbol] by using a portable terminal according to the present invention.

Referring to FIG. 5A, a user of the portable terminal selects a consonant character [symbol] in a state where the portable terminal outputs a character input screen as shown in a screen 501. Thereafter, upon receiving a combination character determination request such as a touch point movement, the portable terminal determines a plurality of characters (e.g., [symbol] , [symbol] combined with the first selected character [symbol] and outputs the characters as shown in a screen 503. The combination character determination request implies a touch movement for outputting the combination character obtained by combining the first selected character and a vowel character.

Accordingly, the user can select a character [symbol] on an output screen as shown in a screen 505.

FIG. 5B illustrates a process of inputting a character [symbol] by using a portable terminal according to the present invention.

Referring to FIG. 5B, a user of the portable terminal selects a consonant character [symbol] in a state where the portable terminal outputs a character input screen as shown in a screen 511. Thereafter, upon receiving a combination character determination request such as a touch point movement, the portable terminal determines a plurality of characters (e.g., [symbol] [symbol] combined with the first selected character [symbol] and outputs the characters as shown in a screen 513.

Thereafter, the portable terminal selects a character [symbol] from the combined characters as shown in the screen 513, and then detects a combination character determination request such as a touch point movement to output a combination character that can be combined with the character [symbol] as shown in a screen 515.

Accordingly, the user of the portable terminal can select a character [symbol] on the output screen.

For example, upon detecting a touch point movement to the right to output a combination character obtained by combining the first selected character and a vowel character, the portable terminal outputs a plurality of characters (e.g., [symbol] combined with the selected character [symbol] . Further, upon detecting a touch point movement downwards to output a combination character obtained by combining the selected character and a final consonant character, the portable terminal outputs a combination character (e.g., [symbol] etc.) obtained by combining the selected character and the final consonant character.

FIG. 5C illustrates a process of inputting a character by using a portable terminal according to the present invention.

Referring to FIG. 5C, a user of the portable terminal selects a consonant character [symbol] in a state where the portable terminal outputs a character input screen as shown in a screen 521. Thereafter, the user moves a touch point upwards to select a consonant character [symbol] . It is assumed herein that the upward movement of the touch point is a touch movement acting as a functional key and displays an alternate character or another variation corresponding to the selected consonant character.

Thereafter, upon detecting a combination character determination request such as a touch point movement (i.e., a movement to the right), the portable terminal determines and outputs a plurality of characters (e.g., [symbol] [symbol] combined with the first selected character [symbol] as shown in a screen 523.

Then, the user of the portable terminal intends to select a character [symbol] and change the touch point to the right, so that another combination character is combined to the right of the character [symbol] .

Then, the portable terminal outputs a screen as shown in a screen 525. The user selects a character [symbol] , and then moves the touch point downwards as a request of combining a final consonant character with the selected character, for example, to select a character [symbol] .

Accordingly, the user of the portable terminal can select a desired character on a screen as shown in a screen 527.

FIG. 5D illustrates a character input process of a portable terminal according to an exemplary embodiment of the present invention.

Referring to FIG. 5D, upon detecting a touch point movement to the right after a consonant character [symbol] is selected in a character input screen as shown in a screen 531, the portable terminal determines all possible characters that can be combined to the right of the first input character [symbol] and outputs a plurality of combination characters as shown in a screen 533.

By determining and outputting all possible characters that can be combined in a direction corresponding to the touch point movement after the first input character is selected, the character input process is simplified in comparison with the processes of FIG. 5A to FIG. 5C.

FIG. 5E illustrates a character input process of a portable terminal according to another exemplary embodiment of the present invention.

Referring to FIG. 5E, the portable terminal selects a consonant character [symbol] on a character input screen as shown in a screen 541. Thereafter, upon detecting a touch point movement in a right-bottom direction, the portable terminal determines all possible characters that can be combined to the right-bottom of the first input character [symbol] and outputs a plurality of combination characters as shown in a screen 543.

By determining and outputting all possible characters that can be combined in a direction corresponding to touch point movement after the first input character is selected, the character input process is simplified in comparison with the processes of FIG. 5A to FIG. 5D.

It should be noted that FIG. 5 illustrates a combination of finger moving directions for illustrative purposes, but the teachings of the present invention may be applicable to other combination of directions and angle of finger movement detected in a first touch screen to a next touch screen.

According to exemplary embodiments of the present invention, a character that can be combined with a first selected character is determined and a character obtained by combining the characters is output so as to enable a fast and quick character input by simplifying a character input process in a portable terminal. As a result, characters can be input simpler and faster than the use of the conventional portable terminal. Therefore, a character input function can be used by a plurality of user classes.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. An apparatus for inputting a character in a portable terminal, the apparatus comprising:
a combination character determination unit for receiving character data selected on a character input screen comprising a plurality of pieces of character data, and then determining character data that can be combined with the selected character data; and
a controller for outputting a combination character obtained by combining characters determined by the combination character determination unit.

2. The apparatus of claim 1, wherein the combination character determination unit determines the character data that can be combined with the selected character data after receiving the selected character data or after detecting a combination character determination request from a user.

3. The apparatus of claim 1, wherein the combination character determination unit determines the character data that can be combined with the selected character data by detecting a touch movement from a position of the selected character data.

4. The apparatus of claim 3, wherein if the touch movement is to right, displaying a plurality of vowel characters can be combined with the selected character data.

5. The apparatus of claim 3, wherein if the touch movement is to downward, displaying a plurality of final consonant characters can be combined with the selected character data.

6. The apparatus of claim 3, wherein if the touch movement is to upward, displaying a plurality of double consonant characters of the selected character for further selection.

7. The apparatus of claim 3, wherein if the touch movement is at an angle, displaying a plurality of all possible characters that can be combined with the selected character data.

8. The apparatus of claim 3, wherein the combination character determination unit determines character data that can be combined with the selected character data by determining whether a touch movement occurs from the selected character, by determining a combination character request corresponding to a touch movement direction, and by determining character data corresponding to the determined combination character request.

9. The apparatus of claim 4, wherein the combination character request corresponding to the touch movement direction comprises at least one of a request for combining the selected character with a vowel character, a request for combining the selected character with a final consonant character, a request for outputting a double consonant character of the selected character, and a request for combining the selected character and a combination character in a direction corresponding to the touch movement direction.

10. A method of inputting a character in a portable terminal, the method comprising:
receiving character data selected on a character input screen comprising a plurality of pieces of character data, and then determining character data that can be combined with the selected character data; and
outputting a combination character obtained by combining the character data.

11. The method of claim 11, wherein the determining of the character data that can be combined with the selected character data is performed after receiving the selected character data or after detecting a combination character determination request from a user.

12. The method of claim 11, wherein the determining of the character data that can be combined with the selected character data is performed by detecting a touch movement from a position of the selected character data.

13. The method of claim 12, wherein if the touch movement is to right, displaying a plurality of vowel characters can be combined with the selected character data.

14. The method of claim 12, wherein if the touch movement is to downward, displaying a plurality of final consonant characters can be combined with the selected character data.

15. The method of claim 12, wherein if the touch movement is to upward, displaying a plurality of double consonant characters of the selected character for further selection.

16. The method of claim 12, wherein if the touch movement is at an angle, displaying a plurality of all possible characters that can be combined with the selected character data.

17. The method of claim 12, wherein the determining of the character data that can be combined with the selected character data comprises:
determining whether a touch movement occurs from the selected character;
determining a combination character request corresponding to a touch movement direction; and
determining character data corresponding to the determined combination character request.

18. The method of claim 13, wherein the combination character request corresponding to the touch movement direction comprises at least one of a request for combining the selected character with a vowel character, a request for combining the selected character with a final consonant character, a request for outputting a double consonant character of the selected character, and a request for combining the selected character and a combination character in a direction corresponding to the touch movement direction.
